(19) United States
(12) Patent Application Publication
(10) Pub. No.: US 2005/0122656 A1
(43) Pub. Date: Jun. 9, 2005

(54) Surface integrated power, communication and data device

(76) Inventor: Yuyi Lee, La Palma, CA (US)

Correspondence Address: CHAN LAW GROUP LC, 1055 W. 7TH ST,, SUITE 1880, LOS ANGELES, CA, 90017, US

(21) Appl. No.: 10/728,703

(22) Filed: Dec. 5, 2003

(51) Int. Cl. H02H 1/00

(52) U.S. Cl. 361/118

(57) ABSTRACT

A surface integrated power, communication and data input device may include power, communication and/or data channels or other suitable paths for power, communication and/or data conduction in a housing that may be attached to furniture, a wall, floor, ceiling or any suitable location by a mounting bracket or other suitable device. Each power, communication and/or data channel may include a power input and at least one power output, a communication input and at least one communication output and a data input and at least one data output, respectively. The power, communication and/or data channels may include discrete surge protection. It is emphasized that this abstract is provided to comply with the rules requiring an abstract, which will allow a searcher or other reader to quickly ascertain the subject matter of the technical disclosure. It is submitted with the understanding that it will not be used to interpret or limit the scope or meaning of the claims.

### BACKGROUND OF THE INVENTION

1. Field of Invention

The present invention relates generally to the field of electronic support equipment and more particularly to surge protected, power, communication and data ports.

2. Background Information

Voltage and/or current changes may damage electronic equipment, resulting in power, communication and/or data loss and even component destruction. Voltage and/or current variations may invade electronic equipment using power, data and/or communication input or output connectors such as, but not limited to power, Ethernet, USB, serial, or phone connections.

Some electronic equipment owners utilize a power surge protector to guard their electrical equipment from potentially damaging input power variations. Voltage and/or current variations may trigger the power surge protector to shut off input power to electrical equipment. The power surge protector may be located adjacent to the electronic equipment on furniture or on the floor. The power input and power output cables connected to the power surge protector may become disorganized and tangled in the vicinity of the electronic equipment.

What is needed is surge protection for power, communication and data connectors suitably integrated with furniture, a wall, floor or ceiling adjacent to or used with computer and/or electronic equipment to minimize disorganization and/or tangling of the input and output cables and provide power, communication and data protection from potentially damaging power variations.

### SUMMARY OF THE INVENTION

A surface integrated power, communication and data input device may include power, communication and/or data channels or other suitable paths for power, communication and/or data conduction in a housing that may be attached to furniture, a wall, floor, ceiling or any suitable location by a mounting bracket or other suitable device. Each power, communication and/or data channel may include a power input and at least one power output, a communication input and at least one communication output and a data input and at least one data output, respectively. The power, communication and/or data channels may include discrete surge protection.

In a first embodiment of the present disclosure, the surface integrated power, communication and/or data input device may be attached to a wall, floor, ceiling or any suitable furniture such as a chair, table, desk, countertop, credenza, sideboard or any suitable location. The surface integrated power, communication and/or data input device may be attached to a wall, floor, ceiling or furniture in any suitable orientation. The power input port and output port cords, communication and data input connector and output cables maybe organized and located inside, under, behind or in any suitable location relative to the surface.

In another embodiment of the present disclosure, the housing may be removably attached to a mounting bracket. A biasing element may be attached to the housing in any suitable location. The biasing element may removably engage the mounting bracket. The biasing element may be a spring metal clip or any suitable fastening or attaching mechanism.

In another embodiment of the present disclosure, a housing flange may removably engage an opening in any suitable surface of a wall, floor, ceiling or suitable furniture such as a table, desk, counter, credenza, sideboard or any suitable work surface or any suitable location. The opening may be rectilinear or any suitable shape. The housing flange may be rectilinear or any shape suitable to engage the opening. The housing flange overlaps and conceals the edge of the opening. The housing flange includes an inner perimeter.

The housing may include a cover surface. The housing may be located within the inner perimeter of the housing flange. A hinge or other pivot mechanism may connect the housing flange to the housing. The housing includes a closed position and an open position relative to the housing flange. When the housing flange is orientated into the closed position, the cover surface of the housing may be substantially flush with the housing flange. The housing may pivot into the open position from the closed position to expose the part of the housing previously positioned below the housing flange to access from above the housing flange.

The housing may also include one or more power input ports one or more power output ports, one or more communication input connectors, one or more communication output connectors, one or more data input connectors and one or more data output connectors. The power input port cord and communication and data input connector cables maybe organized and located inside, under, behind or in any suitable location relative to the furniture.

In another embodiment of the present disclosure, the surface integrated power, communication and/or data input device may include at least one power array or channel, at least one communication array or channel and/or at least one data array or channel. The power array includes a power input port connectable to any conventional AC power outlet. The power input port is connected to at least one power output receptacle. AC power at a suitable voltage such as 110 volts, 125 volts, or 220 volts may be used as input power. The input power is conducted through a power cord and any suitable power cord plug. The at least one data array includes at least one data input connector connected to at least one data output connector. The data connector may be configured to include, but is not limited to RJ45, DSL connection, CAT-5 connection, USB, 9-pin or 25-pin serial connector, parallel connector, SCSI-1 (small computer system interface), SCSI-2, SCSI-3, MIDI or PC keyboard cable, 5 pin DIN, 8 pin DIN or Apple Desktop Bus (ADB). The communication array includes at least one communication input connector connected to at least one communication output connector. The communication connector may be configured to include, but is not limited to RJ11 and/or RJ12. Input to, or output from each communication and data input connector or output connector may be conducted through a suitable cable and connector.

In another embodiment of the present disclosure, a master switch may control input power. The master switch may be a two-position toggle switch or other suitable switch. The two-position toggle switch includes an open and a closed position. Power may be conducted through the master switch to a power output receptacle when the switch is in the closed position.

In another embodiment of the present disclosure, a master switch may control input power and at least one subservient switch may control power output. Each subservient switch may be a two-position toggle switch or other suitable switch. Each two-position toggle switch includes an open and a closed position. Power may be conducted through each subservient switch when the switch is in the closed position. Power may be conducted to each subservient switch when the master switch is closed. Each subservient switch may control power conduction to a respective power output receptacle. Power may be conducted to a power output receptacle when the respective subservient switch and the master switch are closed.

In another embodiment of the present disclosure, power may be conducted from the power input port through a power surge protector prior to conduction to a power output receptacle. Communication signals may be conducted from a communication input connector through a communication surge protector prior to conduction to at least communication output connector. Each communication connector configuration such as RJ11 or RJ12 may have a dedicated surge protector. Data may be conducted from a data input connector through a dedicated surge protector prior to conduction to a data output connector for each data array. Each data connector configuration such as RJ45, USB, DSL connection, CAT-5 connection, 9-pin or 25-pin serial connector, parallel connector, SCSI-1 (small computer system interface), SCSI-2, SCSI-3, MIDI or PC keyboard cable, 5 pin DIN, 8 pin DIN or Apple Desktop Bus (ADB) may have a dedicated surge protector.

In another embodiment of the present disclosure of the surface integrated power, communication and/or data input device, an indicator may be provided to designate the status or position of the master switch. Each subservient switch may also be connected to a respective switch position indicator. The indicator illuminates when power is available to the respective switch output. The indicator may be an incandescent light bulb, light emitting diode or any suitable indicator apparatus.

In another embodiment of the present disclosure, the surface integrated power, communication and/or data input device may include a docking terminal. The docking terminal may include at least one power, at least one data and/or at least one communication connector. The power port configuration may include a power output receptacle. The communication connector may be configured to include any suitable communication connector such as RJ11 or RJ12. The data connector may be configured to include one or more connectors, such as RJ45, DSL connection, CAT-5 connection, USB, 9-pin or 25-pin serial connector, parallel connector, SCSI-1 (small computer system interface), SCSI-2, SCSI-3, MIDI or PC keyboard cable, 5 pin DIN, 8 pin DIN or Apple Desktop Bus (ADB). The docking terminal may be suitable for connection to any suitable electrical equipment such as a laptop computer, palmtop computer, hand-held computer, PDA, telephone, facsimile machine, scanner, speakers, flash drive, joy stick, printer, digital camera and modem or other electronic equipment. At least one indicator may be provided to designate the status of each data output connector, respectively. The electronic equipment may be connected to a suitable power, communication and/or data connector by an appropriate cable.

In another aspect of the present invention, a surface integrated power, communication and data device includes a power array having a power input and at least one power output, a communication array having a communication input and at least one communication output, at least one data array with each data array having a data input and at least one data output, a housing containing the power array, the communication array and each data array and a mounting bracket removably engaging the housing.

In another aspect of the present invention, a surface integrated power, communication and data device includes a power array having a power input and at least one power output, a communication array having a communication input and at least one communication output, at least one data array with each data array having a data input and at least one data output, a housing containing the power array, the communication array and each data array, a housing flange and a pivot mechanism connecting the housing to the housing flange.

Examples in this application, for the sake of simplicity, will be computers. It is understood that all of the examples and that all of the embodiments of the surface integrated power, communication and data device may be used beneficially with many types of electronic equipment, for example, but not limited to computers, facsimile machines, telephones, laptop computer, palmtop computer, hand held computer, PDA, scanner, speakers, digital cameras and modems.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1A is a perspective view of a surface integrated power, communication and data device according to the present disclosure.

FIG. 1B is a back view of the device of FIG. 1A.

FIG. 2 is a block diagram of the surface integrated power, communication and data device of FIG. 1A.

FIG. 3 is a front view of the device of FIG. 1A.

FIG. 4 is a front view of a docking terminal of the device of FIG. 1A.

FIG. 5A is a perspective view of a surface integrated power, communication and data device according to another embodiment of the present disclosure.

FIG. 5B is a back view of the device of FIG. 5A.

FIG. 6 is a block diagram of the surface integrated power, communication and data device of FIG. 5A.

FIG. 7 is a perspective view of another embodiment of a surface integrated power, communication and data device, in an open position according to the present disclosure.

FIG. 8 is a perspective view of device of FIG. 7 in the closed position.

FIG. 9 is a view of the device of FIG. 8 along 9-9′.

FIG. 10 is a view of the device of FIG. 8 along 10-10′.

FIG. 11 is a block diagram of the surface integrated power, communication and data device of FIG. 7.

### DETAILED DESCRIPTION

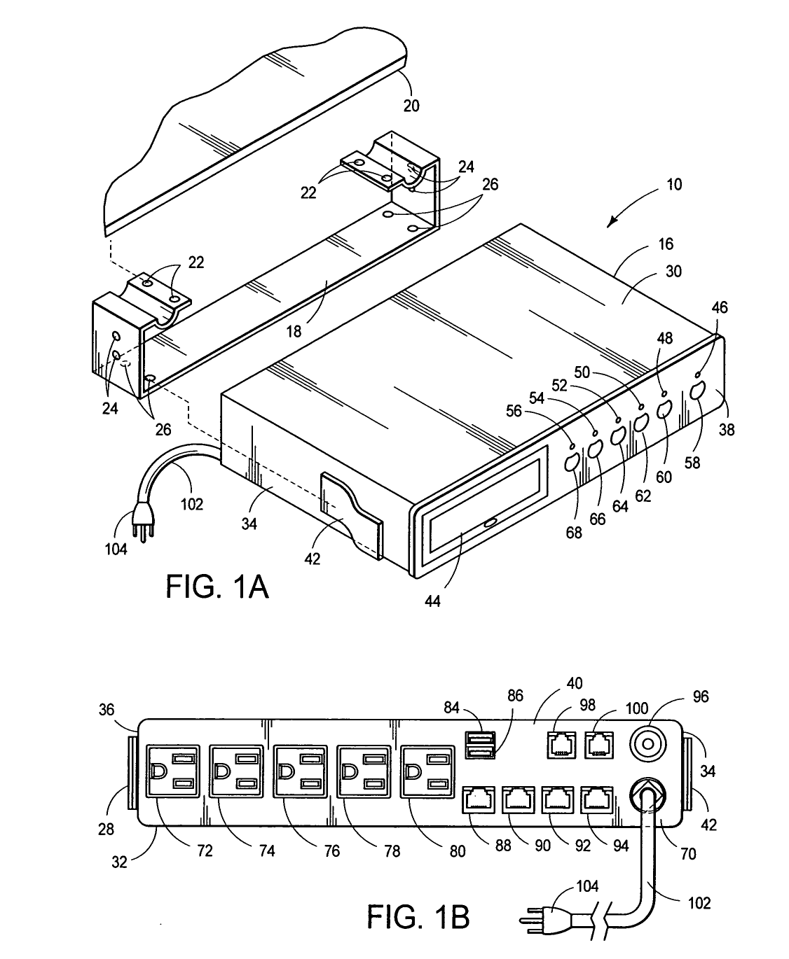

Referring now to FIGS. 1A and 1B, in a currently preferred embodiment of the present disclosure, device 10 includes housing 16 and mounting bracket 18. Mounting bracket 18 may be used to attach housing 16 to surface 20. Housing 16 removably engages mounting bracket 18.

Housing 16 includes top 30, bottom 32, first side 34, second side 36, front panel 38 and back panel 40. Biasing element 42 may be mounted on any suitable location on housing 16 such as first side 34. Biasing element 28 may be mounted on any suitable location on housing 16 such as second side 36. Biasing elements 42 and 28 or any suitable engagement element such as clips or fasteners may be used to removably engage housing 16 to mounting bracket 18. Biasing elements 42 and 28 may be fabricated from spring steel or other suitable material.

Mounting bracket 18 includes holes 22, 24 and 26. Mounting bracket 18 may be attached to surface 20 using holes 22, 24 and/or 26 or any suitable attachment mechanism. Mounting bracket 18 may be attached to surface 20 in any suitable orientation.

Device 10 also includes door 44, indicators 46, 48, 50, 52, 54 and 56, master switch 58, subservient switches 60, 62, 64, 66, 68, power input port 70, power output receptacles 72, 74, 76, 78 and 80, USB output connectors 84, 86, Ethernet input connector 88, Ethernet output connectors 90, 92, 94, reset button 96, communication input connector 98 and communication output connector 100. Connectors, such as USB output connectors 84, 86, Ethernet input connector 88, Ethernet output connectors 90, 92, 94, communication input connector 98 and communication output connector 100, may also be known as ports.

Power input port 70 may include power cord 102 and suitable receptacle plug 104. Receptacle plug 104 is shown as a conventional three-prong male power input plug as used in North America. Electrical power may be supplied through power cord 102 by any suitable source of AC power.

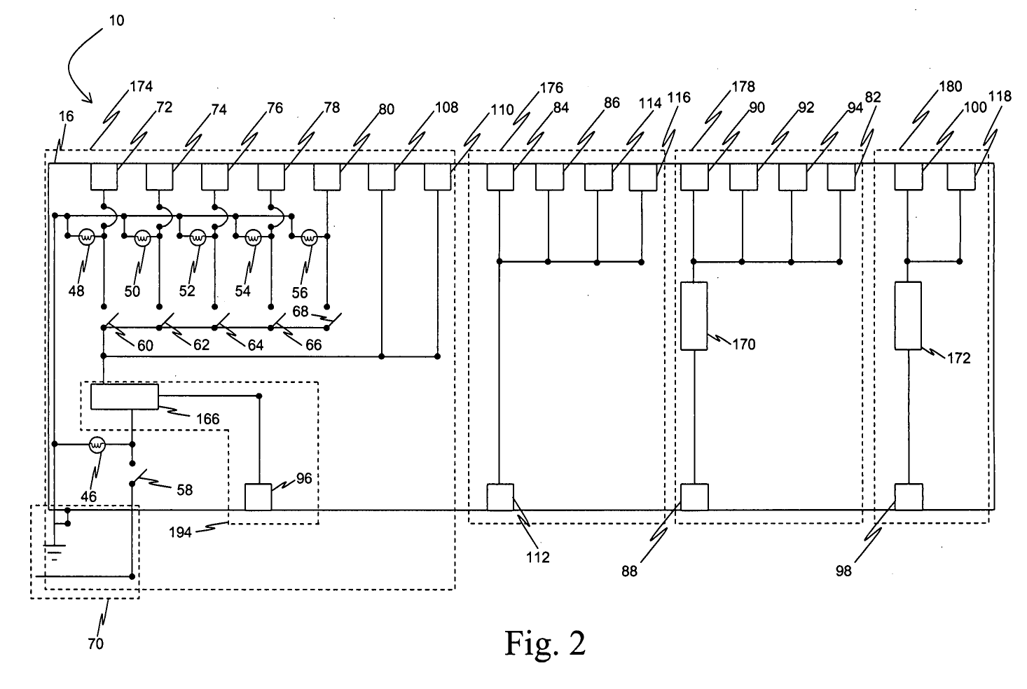

Referring now to FIG. 2, device 10 includes power array 174, USB array 176, Ethernet array 178 and communication array 180.

Power may be conducted through power array 174. Power may be conducted into power array 174 through power input port 70. Power may be conducted out of power array 174 through power output receptacles 72, 74, 76, 78, 80, 108 and/or 110.

Power array 174 may include master switch 58 and subservient switches 60, 62, 64, 66 and 68. Power input port 70 conducts power to master switch 58 and master switch 58 controls power conduction to subservient switches 60, 62, 64, 66 and 68 and power output receptacles 108 and 110. Subservient switches 60, 62, 64, 66 and 68 control power conduction to power output receptacles 72, 74, 76, 78 and 80, respectively. Master switch 58 and subservient switches 60, 62, 64, 66 and 68 may be two-position toggle switches or any suitable switch.

Power may be conducted from master switch 58 through surge protector 166 to each subservient switch 60, 62, 64, 66 and 68.

A surge protector, such as surge protector 166, is an electronic equipment safety device that prevents excessive voltage and/or current conduction and/or excessively rapid current and/or voltage variation conduction. When a surge protector, also known as a surge suppressor, is in a closed position, it may conduct electrical power, data signals or communication signals to electrical equipment connected to the surge protector. The surge protector may open its contacts from the closed position upon detection of an excessive voltage and/or current and/or excessively rapid current and/or voltage variation to prevent conduction through the surge protector to electrical equipment connected to the surge protector. Voltage and/or current and/or rapid current and/or voltage variation may be excessive when it may damage electronic equipment or exceeds the voltage and/or current and/or rapid current and/or voltage variation recommended by the manufacturer of the electronic equipment. A surge protector with open contacts may be reset to the closed position by any suitable means such as a reset button, or the surge protector may be a single use device that must be replaced when its contacts are open. Reset button 96 may be connected to surge protector 166. Activation of reset button 96 may close an open surge protector 166. The combination of reset button 96 and surge protector 166 operates as circuit breaker 194.

Indicator 46 may be connected to master switch 58. Subservient switch status indicators 48, 50, 52, 54 and 56 may be connected to subservient switches 60, 62, 64, 66 and 68, respectively. Master switch status indicator 46 indicates the status of master switch 58 and illuminates when power may be conducted to subservient switches 58, 60, 62, 64, 66, 68 and power output receptacles 108 and 110. Indicators 46, 48, 50, 52, 54 and 56 indicate the status, respectively, of subservient switches 58, 60, 62, 64, 66 and 68 and illuminate when power may be conducted to power output receptacles 72, 74, 76, 78 and 80, respectively. Indicators 46, 48, 50, 52, 54 and 56 may be an incandescent light bulb, light emitting diode or any suitable indicator apparatus.

Data may be conducted through USB array 176. Data may be conducted into USB array 176 through USB input connector 112. Data may be conducted out of USB array 176 through USB output connectors 84, 86, 114 and 116.

Data may be conducted through Ethernet array 178. Data may be conducted from Ethernet input connector 88 to Ethernet output connectors 90, 92, 94, and 82.

Data may be conducted from Ethernet input connector 88 through surge protector 170 prior to conduction to Ethernet output connectors 90, 92, 94, and 82.

Communication signals may be conducted through communication array 180. Communication signals may be conducted from communication input connector 98 to communication output connectors 100 and 118.

Communication signals may be conducted from communication input connector 98 through surge protector 172 prior to conduction to communication output connectors 100 and 118.

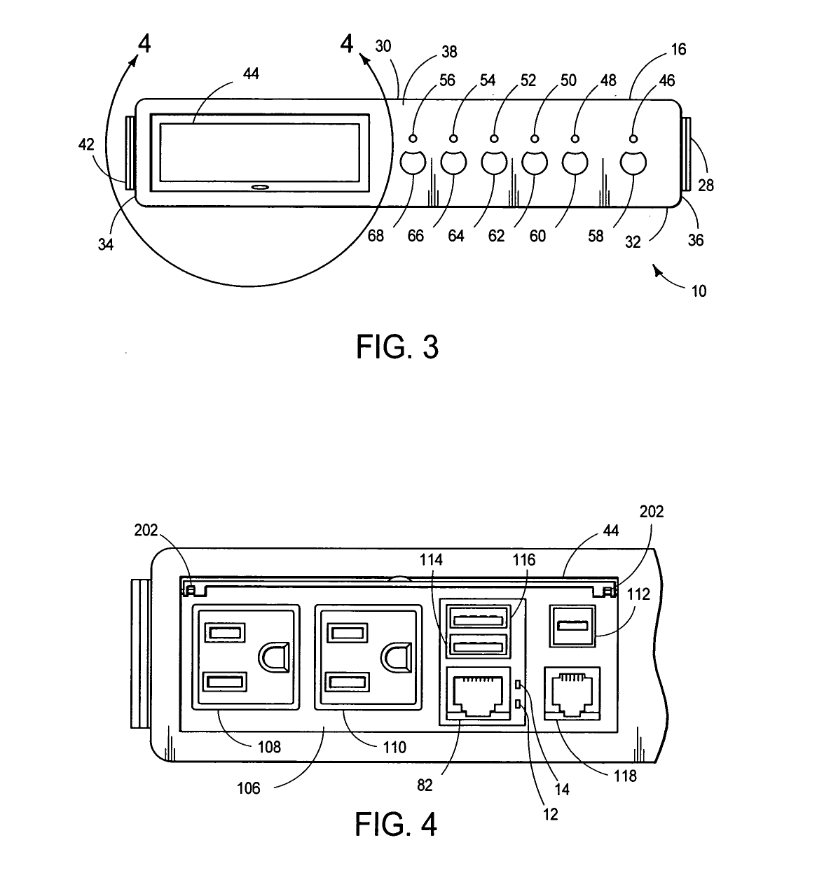

Referring now to FIG. 3, device 10 includes door 44 shielding docking terminal 106.

Referring now to FIG. 4, hinge 202 attaches door 44 to housing 16 or 198. Door 44 pivots on hinge 202. Relative to housing 16 or 198, door 44 may be open or closed. Docking terminal 106 includes power output receptacles 108, 110, USB input connector 112, USB output connectors 114 and 116, Ethernet output connector 82, indicators 12 and 14 and communication output connector 118. A laptop computer, palmtop computer, hand held computer, PDA, telephone, facsimile machine or other suitable apparatus may be connected to a suitable power and/or data input connector by cable. Indicator 14 indicates when data may be conducted through Ethernet output connector 82. Indicator 12 indicates when data may be conducted through USB output connector 114 and/or 116. Indicators 12 and 14 may be an incandescent light bulb, light emitting diode or any suitable indicator apparatus.

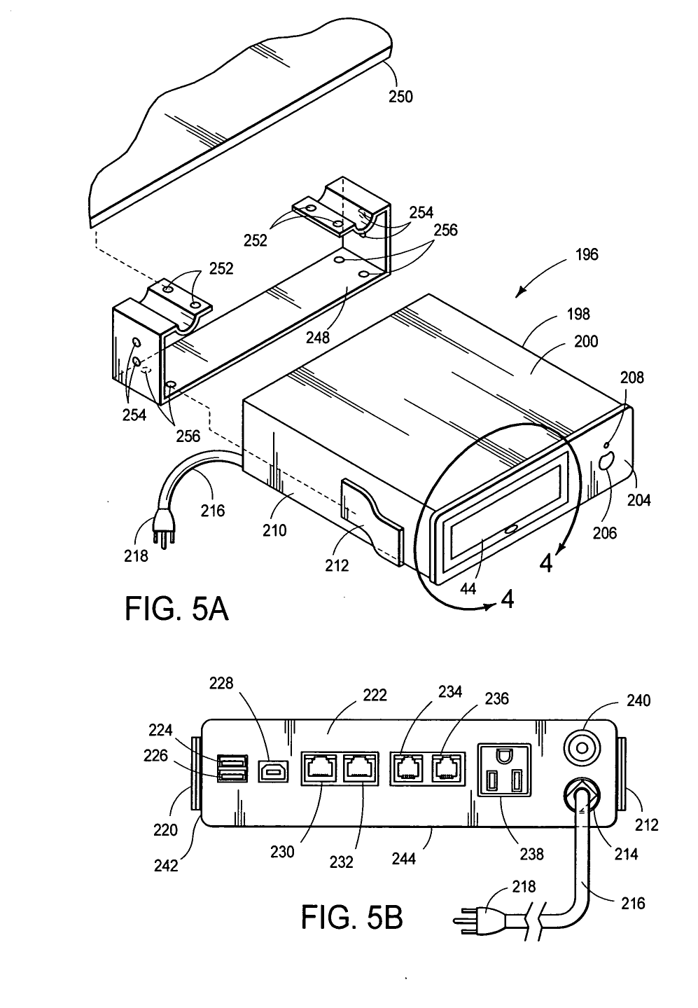

Referring now to FIGS. 5A and 5B, in another currently preferred embodiment of the present disclosure, device 196 includes housing 198 and mounting bracket 248. Mounting bracket 248 may be used to attach housing 198 to surface 250. Housing 198 removably engages mounting bracket 248.

Housing 198 includes top 200, bottom 244, first side 210, second side 242, front panel 204 and back panel 222. Biasing element 212, or any suitable engagement element such as clips or fasteners, may be mounted on any suitable location on housing 198 such as first side 210. Biasing element 220, or any suitable engagement element such as clips or fasteners, may be mounted on any suitable location on housing 198 such as second side 242. Biasing elements 212 and 220 may be fabricated from spring steel or any suitable material.

Mounting bracket 248 includes holes 252, 254 and 256. Mounting bracket 248 may be attached to surface 250 using holes 252, 254 and/or 256. Mounting bracket 248 may be attached to surface 250 in any suitable orientation.

Device 196 also includes door 44, indicator 208, and switch 206, power input port 214, power output receptacle 238, USB input connector 228, USB output connector 224 and 226, Ethernet input connector 230, Ethernet output connector 232, reset button 240, communication input connector 234 and communication output connector 236. Door 44 shields docking terminal 106.

Power input port 214 may include power cord 216 and suitable receptacle plug 218. Receptacle plug 218 is shown as a conventional three-prong male power input plug as used in North America. Electrical power may be supplied through power cord 216 by a suitable source of AC power.

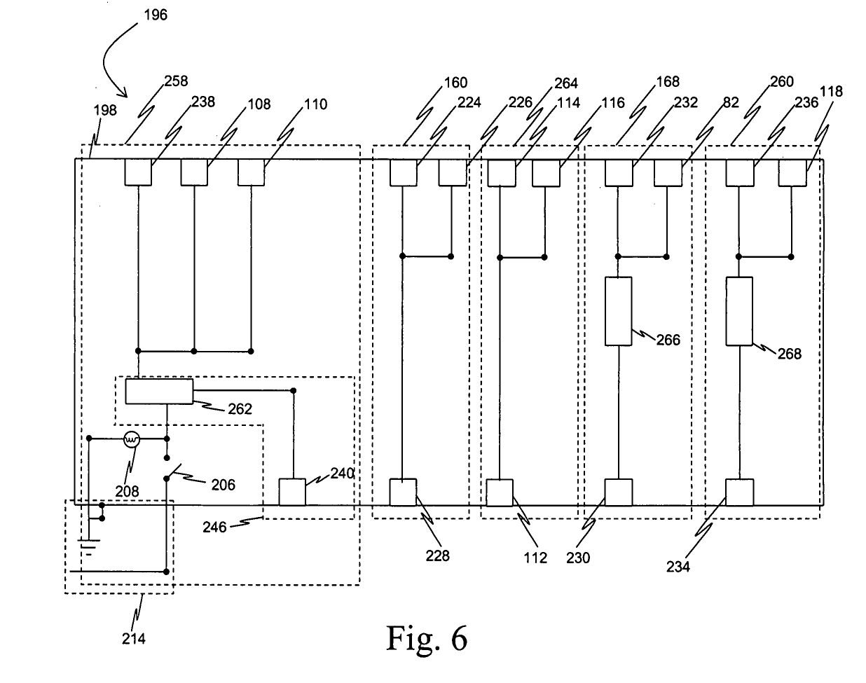

Referring now to FIG. 6, device 196 includes power array 258, USB array 264 and 160, Ethernet array 168 and communication array 260.

Power may be conducted through power array 258. Power may be conducted into power array 258 through power input port 214. Power may be conducted out of power array 258 through power output receptacles 238, 108 and 110.

Power array 258 may include master switch 206. Power input port 214 conducts power to master switch 206 and master switch 206 controls power conduction to power output receptacles 238, 108 and 110. Master switch 206 may be any suitable switch such as a two-position toggle switch.

Power may be conducted from master switch 206 through surge protector 262 to power output receptacles 238, 108 and 110. Reset button 240 may be connected to surge protector 262. Activation of reset button 240 may close an open surge protector 262. The combination of reset button 240 and surge protector 262 operates as circuit breaker 246.

Indicator 208 may be connected to master switch 206. Indicator 208 indicates the status of master switch 206. Indicator 208 illuminates when power may be available at power output receptacles 238, 108 and 110. Indicator 208 may be an incandescent light bulb, light emitting diode or any suitable indicator apparatus.

Data may be conducted through USB array 264 and/or USB array 160. Data may be conducted into USB array 264 through USB input connector 112. Data may be conducted out of USB array 264 through USB output connectors 114 and 116. Data may be conducted into USB array 160 through USB input connector 228. Data may be conducted out of USB array 160 through USB output connectors 224 and 226.

Data may be conducted through Ethernet array 168. Data may be conducted into Ethernet array 168 through Ethernet input connector 230. Data may be conducted out of Ethernet array 168 through Ethernet output connectors 232 and 82.

Data may be conducted from Ethernet input connector 230 through surge protector 266 prior to conduction to Ethernet output connectors 232 and 82.

Communication signals may be conducted through communication array 260. Communication signals may be conducted into communication array 260 through communication input connector 234. Communication signals may be conducted from communication array 260 to communication output connectors 236 and 118.

Communication signals may be conducted from communication input connector 234 through surge protector 268 prior to conduction to communication output connectors 236 and 118.

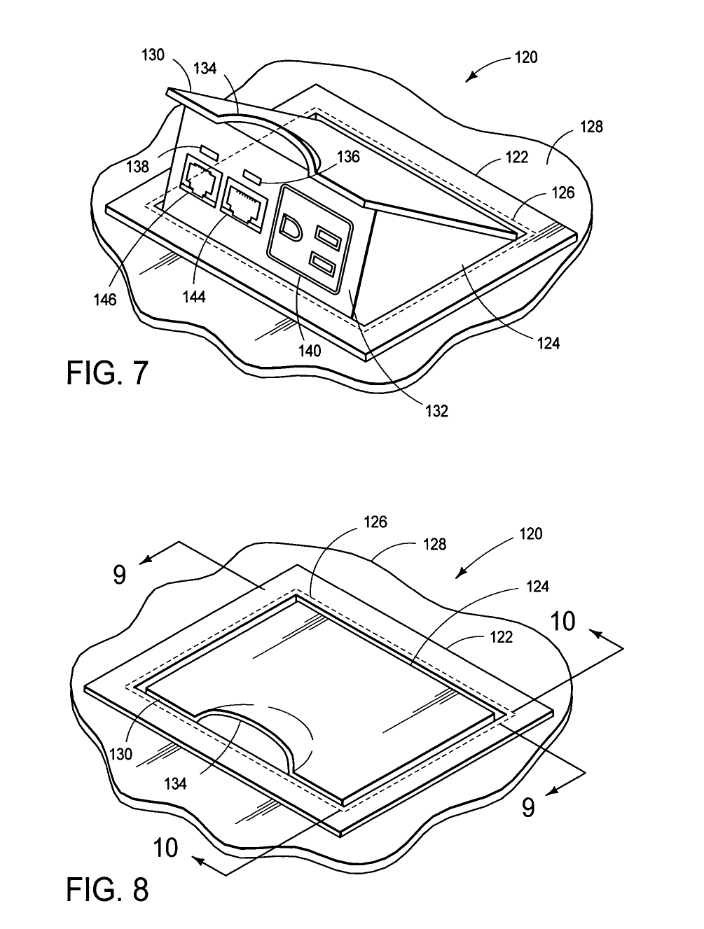

Referring now to FIG. 7, in another currently preferred embodiment of the present disclosure, device 120 may be mounted into surface 128. Device 120 includes housing flange 122 and housing 124. Opening 126 in surface 128 may receive housing flange 122. Housing flange 122 overlaps opening 126 in surface 128. Opening 126 may be in any suitable location in surface 128. Opening 126 may be in any suitable orientation relative to surface 128. Opening 126 may be rectilinear or any suitable shape.

Housing 124 includes cover surface 130, front panel 132, indicators 136 and 138, power output receptacle 140, Ethernet output connector 144, handle 134 and communication output connector 146. Housing 124 is shown open relative to housing flange 122.

Referring now to FIG. 8, housing 124 is shown closed relative to housing flange 122. Cover surface 130 may be substantially flush with the housing flange 122.

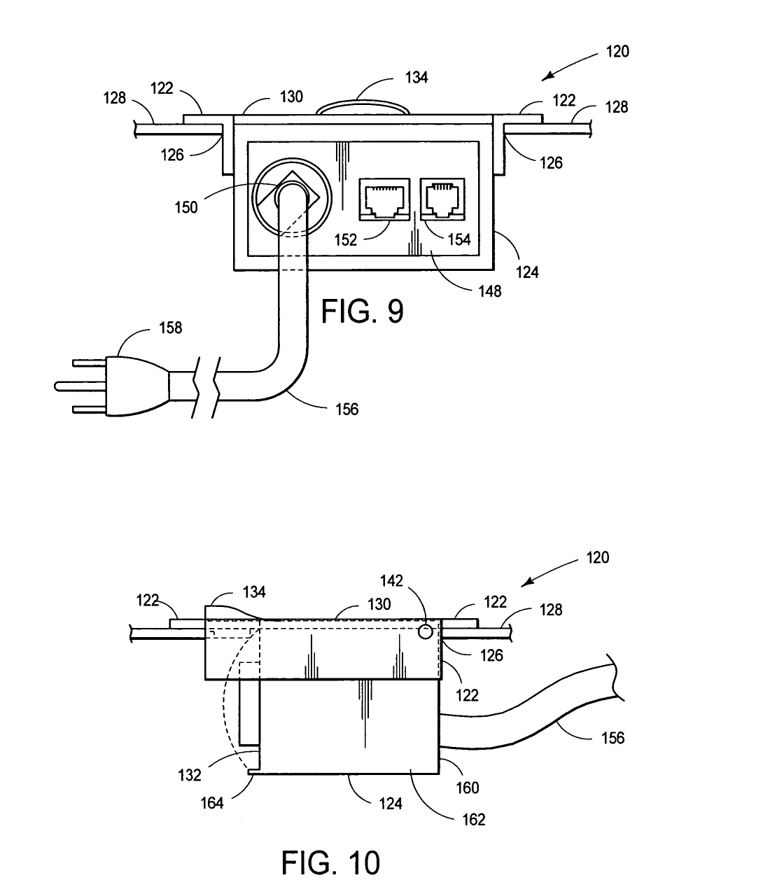

Referring now to FIG. 9, housing 124 may be substantially rectilinear in shape, but any suitable shape may be used. Housing 124 also includes back panel 148, power input port 150, Ethernet input connector 152 and communication input connector 154. Power input port 150 includes power cord 156 and suitable receptacle plug 158. Receptacle plug 158 is shown as a conventional three-prong male power input plug as used in North America. Electrical power may be supplied through power cord 156 by a suitable source of AC power.

Referring now to FIG. 10, device 120 also includes side panel 162 and hinge 142. Hinge 142 connects housing flange 122 to housing 124. Housing 124 may pivot on hinge 142 relative to housing flange 122 to expose the part of the housing 124 previously positioned below housing flange 122 to access from above housing flange 122. Housing 124 may pivot until stop 164 butts against housing flange 122.

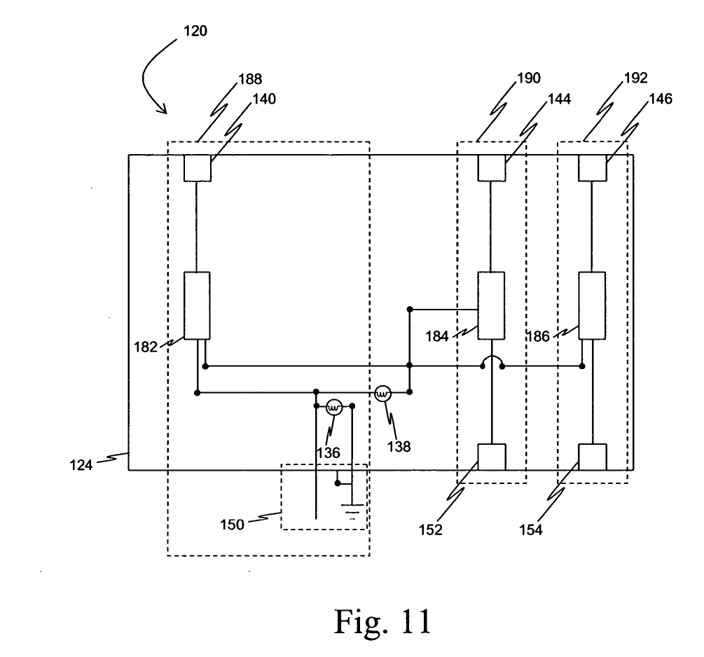

Referring now to FIG. 11, device 120 also includes power channel 188, data channel 190 and communication channel 192.

Power may be conducted through power channel 188. Power channel 188 includes power input port 150 and power output receptacle 140. Power may be conducted from power input port 150 through surge protector 182 prior to conduction to power output receptacle 140.

Indicator 136 indicates when power output receptacle 140 may not be electrically grounded. Ground status indicator 136 may be an incandescent light bulb, light emitting diode or any suitable indicator apparatus.

Data may be conducted through data channel 190. Data channel 190 includes Ethernet input connector 152 and Ethernet output connector 144. Data may be conducted from Ethernet input connector 152 through surge protector 184 prior to conduction to Ethernet output connector 144.

Communication signals may be conducted through communication channel 192. Communication channel 192 includes communication input connector 154 and communication output connector 146. Communication signals may be conducted from communication input connector 154 through surge protector 186 prior to conduction to communication output connector 146.

Indicator 138 indicates the status of surge protector 182, surge protector 184 and surge protector 186. Surge protector status indicator 138 may indicate when surge protector 182, surge protector 184 and/or surge protector 186 have open contacts. Surge protector status indicator 138 may indicate when surge protector 182, surge protector 184 and/or surge protector 186 are in the closed position. Surge protector status indicator 138 may be an incandescent light bulb, light emitting diode or any suitable indicator apparatus.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims and their legal equivalents.

1. A surface integrated power, communication and data device comprising:
a power array having a power input and at least one power output;
a communication array having a communication input and at least one communication output;
at least one data array, each data array having a data input and at least one data output;
a housing containing the power array, the communication array and each data array; and
a mounting bracket removably engaging the housing.

2. The surface integrated power, communication and data device according to claim 1 wherein the communication input and the at least one communication output are selected from the group consisting of:
RJ11 connectors and RJ12 connectors.

3. The surface integrated power, communication and data device according to claim 1 wherein the data input and the at least one data output are selected from the group consisting of:
universal serial bus connectors, Cat-5 connection connectors, DSL connection connectors, RJ45 connectors, 9-pin serial connectors, 25-pin serial connectors, SCSI-1 connectors, SCSI-2 connectors, SCSI-3 connectors, MIDI 5 pin DIN connectors, ADB ports and parallel connectors.

4. The surface integrated power, communication and data device according to claim 1 further comprising:
a power surge protector connected between the power input and the at least one power output;
a communication surge protector connected between the communication input and the at least one communication output; and
a data surge protector connected between the data input and the at least one data output of a first data array.

5. The surface integrated power, communication and data device according to claim 4 further comprising:
a reset button to reset the power surge protector.

6. The surface integrated power, communication and data device according to claim 1 wherein:
a master switch controls the power input.

7. The surface integrated power, communication and data device according to claim 1 wherein:
at least one subservient switch controls a first power output.

8. The surface integrated power, communication and data device according to claim 6 further comprising:
a master switch status indicator.

9. The surface integrated power, communication and data device according to claim 7 further comprising:
at least one subservient switch status indicator.

10. A surface integrated power, communication and data device comprising:
a power array having a power input and at least one power output;
a communication array having a communication input and at least one communication output;
at least one data array, each data array having a data input and at least one data output;
a housing containing the power array, the communication array and each data array;
a housing flange; and
a pivot mechanism connecting the housing to the housing flange.

11. The surface integrated power, communication and data device according to claim 10 wherein the communication input and the at least one communication output are selected from the group consisting of:
RJ11 connectors and RJ12 connectors.

12. The surface integrated power, communication and data device according to claim 10 wherein the data input and the at least one data output are selected from the group consisting of:
universal serial bus connectors, Cat-5 connection connectors, DSL connection connectors, RJ45 connectors, 9-pin serial connectors, 25-pin serial connectors, SCSI-1 connectors, SCSI-2 connectors, SCSI-3 connectors, MIDI 5 pin DIN connectors, ADB ports and parallel connectors.

13. The surface integrated power, communication and data device according to claim 10 wherein the pivot mechanism is a hinge.

14. The surface integrated power, communication and data device according to claim 10 further comprising:
an open ground indicator connected to the power array.

15. The surface integrated power, communication and data device according to claim 10 further comprising:
a power surge protector connected between the power input and the at least one power output;
a communication surge protector connected between the communication input and the at least one communication output; and
a data surge protector connected between the data input and the at least one data output of a first data array.

16. The surface integrated power, communication and data device according to claim 15 further comprising:
a surge protector status indicator connected to the power surge protector, communication surge protector and each data surge protector.
